(19) United States
(12) Patent Application Publication
(10) Pub. No.: US 2025/0010722 A1
(43) Pub. Date: Jan. 9, 2025

(54) REGENERATIVE BRAKING CONTROL METHOD OF VEHICLE

(71) Applicants: Hyundai Motor Company, Seoul (KR); Kia Corporation, Seoul (KR)

(72) Inventors: Jin Yong KIM, Daegu (KR); Chang Eun Na, Seongnam-Si (KR); Hong Gi Park, Seoul (KR); Hyun Seok Jang, Daegu (KR)

(73) Assignees: Hyundai Motor Company, Seoul (KR); Kia Corporation, Seoul (KR)

(21) Appl. No.: 18/388,005

(22) Filed: Nov. 8, 2023

(30) Foreign Application Priority Data
Jul. 7, 2023 (KR) 10-2023-0088412

(51) Int. Cl. B60L 7/18

(52) U.S. Cl. CPC B60L 7/18; B60L 2240/12; B60L 2240/642; B60L 2240/68; B60L 2240/70; B60L 2250/28; B60L 2260/24; B60L 2260/26

(57) ABSTRACT

A regenerative braking control method of a vehicle, includes determining whether a designated downhill cruise condition is satisfied, when an accelerator pedal is released in an ON state of a regenerative braking switch, setting a target deceleration of the vehicle to a designated deceleration for downhill cruising, when a designated preliminary obstacle is not present ahead of the vehicle, upon concluding that the downhill cruise condition is satisfied, determining torque required for the vehicle to decelerate at the target deceleration, and generating the required torque in the vehicle preferentially using regenerative braking.

### CROSS-REFERENCE TO RELATED APPLICATION

The present application claims priority to Korean Patent Application No. 10-2023-0088412, filed on Jul. 7, 2023, the entire contents of which is incorporated herein for all purposes by this reference.

### BACKGROUND OF THE PRESENT DISCLOSURE

### Field of the Present Disclosure

The present disclosure relates to a technology for controlling regenerative braking torque of a vehicle.

### DESCRIPTION OF RELATED ART

A lever-type or paddle-shape regenerative braking apparatus may be provided in conventional eco-friendly commercial vehicles, and a considerable number of drivers use the regenerative braking apparatus in a steady state without further manipulation rather than actively manipulating the regenerative braking apparatus appropriately for the driving state of a vehicle.

The reason for this is that it is cumbersome for a driver to manipulate the regenerative braking apparatus depending on the driving state of the vehicle to properly adjust an amount of regenerative braking of the vehicle depending on the driving state of the vehicle, and when the regenerative braking apparatus is not properly controlled, the amount of regenerative braking of the vehicle is not properly controlled, and thus, energy efficiency of the vehicle is relatively deteriorated.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a regenerative braking control method of a vehicle in which an amount of regenerative braking suitable for a driving situation of the vehicle may be automatically controlled while improving driving convenience by minimizing driver's manipulation for regenerative braking, to greatly improve energy efficiency of the vehicle.

In accordance with an aspect of the present disclosure, the above and other objects may be accomplished by the provision of a regenerative braking control method of a vehicle, including determining whether or not a designated downhill cruise condition is satisfied, in response that an accelerator pedal is released in an ON state of a regenerative braking switch, setting a target deceleration of the vehicle to a designated deceleration for downhill cruising, in response that a designated preliminary obstacle is not present ahead of the vehicle, upon concluding that the downhill cruise condition is satisfied, determining torque required for the vehicle to decelerate at the target deceleration, and generating the required torque in the vehicle preferentially using regenerative braking.

It may be determined that the downhill cruise condition is satisfied, in response that a current vehicle speed is equal to or greater than a target vehicle speed determined by adding a designated pre-input vehicle speed value to a vehicle speed in response that the accelerator pedal is released in the ON state of the regenerative braking switch.

Upon concluding that the downhill cruise condition is not satisfied, the target deceleration may be set to a minimum value among candidate decelerations determined depending on a slope of a road on which the vehicle is running and the preliminary obstacle.

In response that the road on which the vehicle is running is a flat road or an uphill road, one of the candidate decelerations may be determined a deceleration for coasting, and the deceleration for coasting may be a predetermined constant value.

In response that the road on which the vehicle is running is a downhill road, one of the candidate decelerations may be determined the deceleration for downhill cruising, and the deceleration for downhill cruising may be set depending on a difference between the target vehicle speed and the current vehicle speed.

In response that the preliminary obstacle is a speed camera, one of the candidate decelerations may be determined a deceleration for stationary obstacles, and the deceleration for stationary obstacles may be set to a deceleration required for the vehicle to reach a speed limit of the speed camera, in response that the vehicle reaches an enforcement position of the speed camera.

The deceleration for stationary obstacles may be determined by a following Equation.

$${a}_{cam} = \frac{( {v}_{cam}^{2} - {v}_{cur}^{2} )}{2 \times max ( {d}_{cam} , {d}_{min} )}$$

a_{cam}: deceleration for stationary obstacles
v_{cam}: speed limit of limit camera
v_{cur}: current vehicle speed
d_{cam}: distance from current position of vehicle to speed camera
dₘᵢₙ: minimum distance for preventing division by zero

In response that the preliminary obstacle is a preceding vehicle, one of the candidate decelerations may be determined a deceleration for moving obstacles, and the deceleration for moving obstacles may be set to a deceleration required for the vehicle to maintain a proper inter-vehicle distance with the preceding vehicle.

The deceleration for moving obstacles may be one selected from a deceleration for moving obstacles based on a first mode configured to be advantageous in maintaining the proper inter-vehicle distance with the preceding vehicle during braking of the preceding vehicle, and a deceleration for moving obstacles based on a second mode configured to be advantageous in maintaining the proper inter-vehicle distance with the preceding vehicle during cruising of the preceding vehicle.

The deceleration for moving obstacles may be determined by following Equations.

$${a}_{ref} = β \times {a}_{ctg} + ( 1 - β ) \times {a}_{ca} \\ {a}_{ctg} = - \frac{1}{h} [ λ ( {v}_{ego} \times h + {d}_{min} - {d}_{rel} ) - {v}_{rel} ] \\ {a}_{ca} = \frac{( {v}_{front}^{2} - {v}_{ego}^{2} )}{2 \times {d}_{rel}} at Mode 1 \\ {a}_{ca} = \frac{{( {v}_{front} - {v}_{ego} )}^{2}}{2 \times ( {d}_{rel} - D )} at Mode 2$$

a_{ref}: deceleration for moving obstacles
β: mixing ratio (tuning value depending on relative speed and relative distance)
h: time gap constant in constant time gap control
λ: sliding gradient (as sliding gradient increases, distance control becomes faster)
v_{ego}: speed of host vehicle
dₘᵢₙ: minimum distance to be maintained
dᵣₑₗ: distance with preceding vehicle
vᵣₑₗ: relative speed
v_{front}: speed of preceding vehicle
D: proper inter-vehicle distance

The proper inter-vehicle distance D may be determined from a map representing an inter-vehicle distance depending on the current vehicle speed and a relative speed of the vehicle.

Upon determining that the downhill cruise condition is satisfied, in response that the preliminary obstacle is present ahead, the target deceleration may be set to the minimum value among the candidate decelerations.

The required torque may be determined by adding slope compensation torque, air resistance compensation torque, and rolling resistance compensation torque to reference torque, obtained by multiplying the target deceleration by a vehicle weight and a dynamic loaded radius of tires.

The required torque may be determined by adding slope compensation torque and feedback compensation torque to reference torque, obtained by multiplying the target deceleration by a vehicle weight and a dynamic loaded radius of tires.

The feedback compensation torque may be determined by a following equation.

$${T}_{fb} = {T}_{mot} + {T}_{rtd} - r \times \hat{m} \times {a}_{veh}$$

T_{fb}: feedback compensation torque
Tₘₒₜ: motor torque
T_{rtd}: retarder torque
r: dynamic loaded radius of tires
\hat{m}: estimated vehicle weight
aᵥₑₕ: current acceleration of vehicle

In generating the required torque in the vehicle, in response that a vehicle speed is reduced to a designated conversion speed or less than the designated conversion speed, regenerative braking torque may be gradually substituted with retarder torque.

In accordance with another aspect of the present disclosure, there is provided a regenerative braking control system of a vehicle, including a controller configured to execute the above regenerative braking control method, the regenerative braking switch configured to provide a signal indicating user's selection of activation of a regenerative braking function of the vehicle to the controller, an accelerator pedal sensor configured to detect release of the accelerator pedal and to provide information related to the accelerator pedal to the controller, and a motor and a retarder controlled by the controller and configured to generate the required torque in the vehicle.

The regenerative braking control system may further include a navigation system configured to provide information related to speed cameras ahead on a road on which the vehicle is running, and at least one of a front camera or a front radio detection and ranging (RADAR) configured to detect information related to preceding vehicles ahead on the road on which the vehicle is running.

The regenerative braking control system may further include a mode selection switch configured to select determination of the target deceleration as a different value, in response that a preceding vehicle is present ahead.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of a regenerative braking control system of a vehicle according to an exemplary embodiment of the present disclosure;

FIG. 2 and FIG. 3 are flowcharts representing a regenerative braking control method of a vehicle according to an exemplary embodiment of the present disclosure; and

FIG. 4 is a map representing an inter-vehicle distance depending on a vehicle speed and a relative speed.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Reference will now be made in detail to exemplary embodiments of the present disclosure, examples of which are illustrated in the accompanying drawings. Wherever possible, the same reference numbers will be used throughout the drawings to refer to the same or like parts, and a redundant description thereof will be omitted.

In the following description of the embodiments, suffixes, such as “module”, “part” and “unit”, are provided or used interchangeably merely in consideration of ease in statement of the specification, and do not have meanings or functions distinguished from one another.

In the following description of the exemplary embodiments of the present disclosure, a detailed description of known functions and configurations incorporated herein will be omitted when it may make the subject matter of the present disclosure rather unclear. Furthermore, the accompanying drawings will be exemplarily provided to describe the exemplary embodiments of the present disclosure, and should not be construed as being limited to the exemplary embodiments set forth herein, and it will be understood that the exemplary embodiments of the present disclosure are provided only to completely include the present disclosure and cover modifications, equivalents or alternatives which come within the scope and technical range of the present disclosure.

In the following description of the embodiments, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

As used herein, singular expressions may be intended to encompass plural expressions as well, unless the context clearly indicates otherwise.

In the following description of the embodiments, the terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

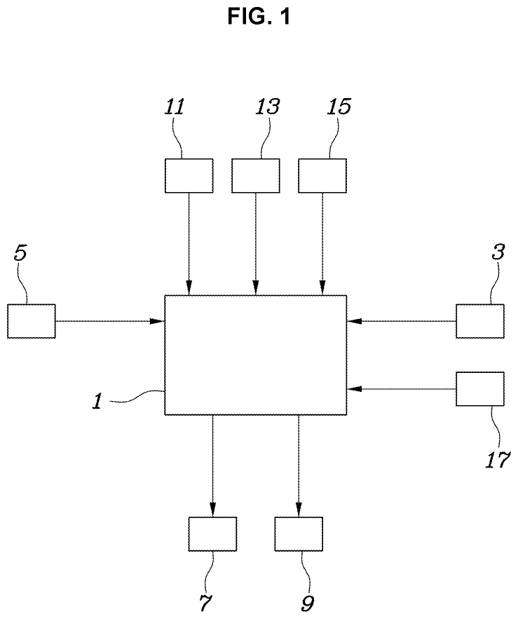

Referring to FIG. 1, a regenerative braking control system of a vehicle according to an exemplary embodiment of the present disclosure includes a controller 1 configured to execute a regenerative braking control method, which will be described below, a regenerative braking switch 3 configured to provide a signal indicating user's selection of activation of a regenerative braking function of the vehicle to the controller 1, an accelerator pedal sensor 5 configured to detect release of an accelerator pedal and to provide information related to the accelerator pedal to the controller 1, and a motor 7 and a retarder 9 controlled by the controller 1 and configured to generate torque required by the vehicle.

That is, the regenerative braking switch 3 is provided to be turned on by a user, such as a driver, to activate the regenerative braking control function of the vehicle, or to be turned off by the user, and the controller 1 automatically executes the regenerative braking control method according to an exemplary embodiment of the present disclosure, which will be described below, depending on the driving situation of the vehicle only by turning on the regenerative braking switch 3.

Furthermore, the regenerative braking control system according to an exemplary embodiment of the present disclosure may include a navigation system 11 configured to provide information related to speed cameras ahead on a road on which the vehicle is running, and at least one of a front camera 13 or a front radio detection and ranging (RADAR) 15 configured to detect information related to preceding vehicles ahead on the road on which the vehicle is running.

Furthermore, information related to physical quantities related to driving of the vehicle, such as a vehicle speed and a vehicle acceleration, is input to the controller 1 from various sensors of the vehicle which are not shown.

Furthermore, the regenerative braking control system according to an exemplary embodiment of the present disclosure may include a mode selection switch 17 configured to select determination of a target deceleration, which will be described below, as a different value, when a preceding vehicle is present ahead.

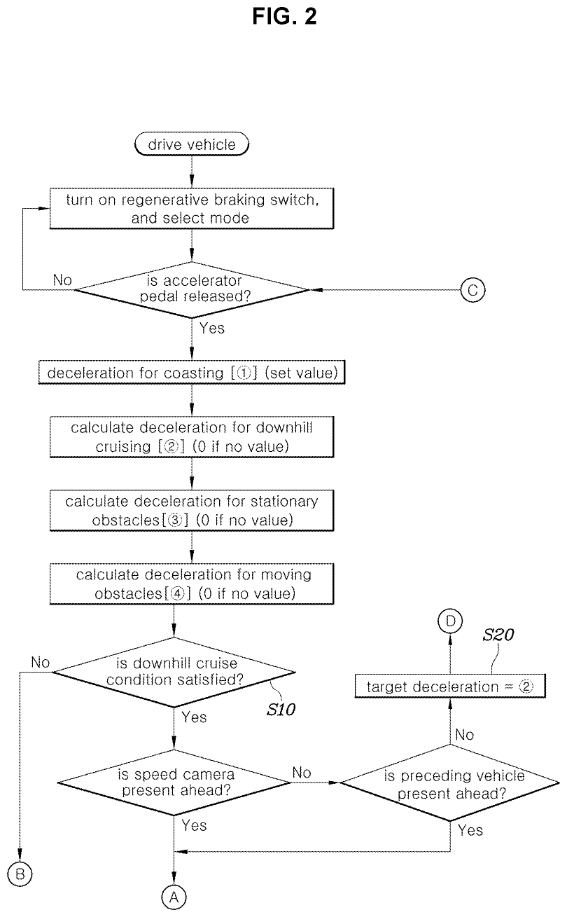

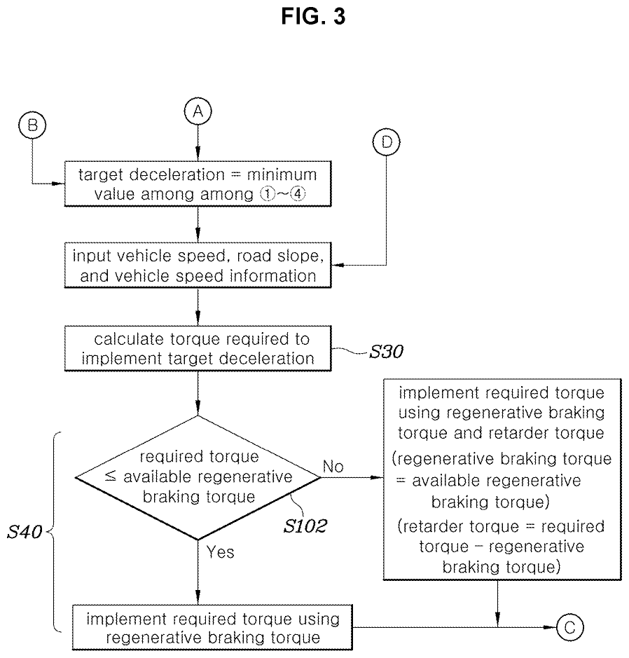

Referring to FIG. 2 and FIG. 3, the regenerative braking control method of the vehicle according to various exemplary embodiments of the present disclosure includes determining whether or not a designated downhill cruise condition is satisfied, when the accelerator pedal is released in the ON state of the regenerative braking switch 3 (S10), setting a target deceleration of the vehicle to a designated deceleration for downhill cruising, when a designated preliminary obstacle is not present ahead of the vehicle, upon concluding that the downhill cruise condition is satisfied (S20), determining required torque of the vehicle, i.e., torque required for the vehicle to decelerate at the target deceleration (S30), and generating the required torque in the vehicle preferentially using regenerative braking.

That is, the controller 1 is configured to determine whether or not the downhill cruise condition is satisfied, when it is confirmed that a driver has no intention of accelerating the vehicle any more from an accelerator pedal sensor 5 from release of the accelerator pedal in the ON state of the regenerative braking switch 3.

The downhill cruise condition may be set to be satisfied, when a current vehicle speed is equal to or greater than a target vehicle speed determined by adding a designated pre-input vehicle speed value to a vehicle speed when the accelerator pedal is released in the ON state of the regenerative braking switch 3.

Here, the pre-input vehicle speed value is a tuning value which may be set to, for example, 1 kph, 2 kph, or the like, the sum total obtained by adding the pre-input vehicle speed value to the vehicle speed when the accelerator pedal is released becomes the target vehicle speed, and it is determined that the downhill cruise condition is satisfied when the current vehicle speed is equal to or greater than the target vehicle speed.

That is, the downhill cruise condition is satisfied when the vehicle speed is equal to or greater than the target vehicle speed obtained by adding a slight margin of the pre-input vehicle speed to the vehicle speed at a point in time when the driver releases the accelerator pedal, and the vehicle automatically enters a downhill cruise state by setting the target deceleration of the vehicle to the deceleration for downhill cruising, when the preliminary obstacle is not present ahead, and controlling the vehicle with torque required for the vehicle to decelerate at the target deceleration.

Therefore, according to an exemplary embodiment of the present disclosure, on the assumption that the regenerative braking switch 3 is turned on, only when the driver releases the accelerator pedal, the vehicle is automatically decelerated at the deceleration for downhill cruising, upon concluding that the downhill cruise condition is satisfied, and consequently, the vehicle is in the downhill cruise state.

Of course, the controller 1 decelerates the vehicle at a different target deceleration, when the downhill cruise condition is not satisfied or in different driving situations, such as when the preliminary obstacle is present, and in the instant case, the regenerative braking function of the vehicle is also preferentially used.

Therefore, the regenerative braking control method according to an exemplary embodiment of the present disclosure does not require manipulation of a separate switch to cruise the vehicle on a downhill road unlike the conventional method, being capable of increasing the amount of regenerative braking of the vehicle while greatly improving driver's convenience, and thus greatly contributing to improvement of energy efficiency of the vehicle.

When the downhill cruise condition is not satisfied, the target deceleration is set to the minimum value among candidate decelerations determined depending on the slope of the road on which the vehicle is running and the preliminary obstacle.

Here, the candidate decelerations may be determined before determination of the downhill cruise condition, as in the exemplary embodiment shown in FIG. 2.

For reference, a deceleration for coasting is set in advance to a constant value, as described below, and although FIG. 2 illustrates that a process of setting the deceleration for coasting is performed when the accelerator pedal is released, the process of setting the deceleration for coasting is actually omitted.

Furthermore, although FIG. 2 illustrates that a process of determining the deceleration for downhill cruising, a process of determining a deceleration for stationary obstacles, and a process of determining a deceleration for moving obstacles are sequentially performed, these processes may be performed concurrently or in a different order.

When the road on which the vehicle is running is a flat road or an uphill road, one of the candidate decelerations is determined the deceleration for coasting, and the deceleration for coasting is a predetermined constant value.

For example, the deceleration for coasting may be set to a designated constant value, such as 0.3 m/s² or 0.4 m/s².

When the road on which the vehicle is running is a flat road or an uphill road, the target deceleration is set to the deceleration for coasting including the above-described constant, the required torque to satisfy the target deceleration is determined, and the vehicle is controlled at the required torque.

A commercial vehicle, such as a truck, has a great change in the weight thereof and thus essentially requires compensation of the vehicle weight and the slope of the road during regenerative braking control of the vehicle, and in an exemplary embodiment of the present disclosure, compensation of the vehicle weight and the slope of the road may be accomplished during the process of determining the required torque, to implement the deceleration of the vehicle set to the constant value.

Consequently, the amount of regenerative braking of the vehicle is increased when the vehicle weight is increased, and the amount of regenerative braking of the vehicle is decreased when the vehicle travels on an uphill road.

When the road on which the vehicle is running is a downhill road, one of the candidate decelerations is determined the deceleration for downhill cruising, and the deceleration for downhill cruising is set depending on a difference between the target vehicle speed and the current vehicle speed.

For example, the deceleration for downhill cruising may be set to be proportional to the difference between the target vehicle speed and the current vehicle speed.

In the instant case, when the current vehicle speed becomes greater than the target vehicle speed, the deceleration for downhill cruising is increased, and thereby, when the vehicle speed increases on a downhill road, the vehicle is decelerated at a deceleration which is increased as much as an increase in the difference between the target vehicle speed and the current vehicle speed, and thus, the current vehicle speed may be rapidly converged on the target vehicle speed.

Here, the preliminary obstacle in front of the vehicle includes a speed camera, a preceding vehicle, or the like.

When the preliminary obstacle is a speed camera, one of the candidate decelerations is determined the deceleration for stationary obstacles.

The deceleration for stationary obstacles is set to a deceleration required for the vehicle to reach the speed limit of the speed camera, when the vehicle reaches an enforcement position of the speed camera.

That is, the deceleration for stationary obstacles may be determined by the following Equation.

$${a}_{cam} = \frac{( {v}_{cam}^{2} - {v}_{cur}^{2} )}{2 \times max ( {d}_{cam} , {d}_{min} )}$$

a_{cam}: deceleration for stationary obstacles
v_{cam}: speed limit of limit camera
v_{cur}: current vehicle speed
d_{cam}: distance from current position of vehicle to speed camera
dₘᵢₙ: minimum distance for preventing division by zero

That is, when a speed camera is present ahead on the road on which the vehicle is running, the controller 1, which has obtained information related to the speed camera from equipment, such as the navigation system 11, is configured to determine the deceleration for stationary obstacles by the above-described equation, is configured to determine the required torque, and satisfies the required torque preferentially using regenerative braking of the vehicle, being capable of maximally performing regenerative braking as much as possible while decelerating the vehicle so as not to exceed the speed limit, when the vehicle reaches the enforcement position of the speed camera.

When the preliminary obstacle is a preceding vehicle, one of the candidate decelerations is determined the deceleration for moving obstacles.

The deceleration for moving obstacles is set to a deceleration required for the vehicle to maintain a proper inter-vehicle distance with the preceding vehicle.

In the exemplary embodiment of the present disclosure, the deceleration for moving obstacles may be one selected from a deceleration for moving obstacles based on a first mode which is advantageous in maintaining the proper inter-vehicle distance with the preceding vehicle during braking of the preceding vehicle, and a deceleration for moving obstacles based on a second mode which is advantageous in maintaining the proper inter-vehicle distance with the preceding vehicle during cruising of the preceding vehicle.

That is, the deceleration for moving obstacles may be determined by the following Equations.

$${a}_{ref} = β \times {a}_{ctg} + ( 1 - β ) \times {a}_{ca} \\ {a}_{ctg} = - \frac{1}{h} [ λ ( {v}_{ego} \times h + {d}_{min} - {d}_{rel} ) - {v}_{rel} ] \\ {a}_{ca} = \frac{( {v}_{front}^{2} - {v}_{ego}^{2} )}{2 \times {d}_{rel}} at Mode 1 \\ {a}_{ca} = \frac{{( {v}_{front} - {v}_{ego} )}^{2}}{2 \times ( {d}_{rel} - D )} at Mode 2$$

a_{ref}: deceleration for moving obstacles
β: mixing ratio (tuning value depending on relative speed and relative distance), wherein the relative speed refers to the difference in speed between the host vehicle and the preceding vehicle, and the relative distance refers to the distance between the host vehicle and the preceding vehicle.
h: time gap constant in constant time gap control
λ: sliding gradient (as sliding gradient increases, distance control becomes faster)
v_{ego}: speed of host vehicle
dₘᵢₙ: minimum distance to be maintained
dᵣₑₗ: distance with preceding vehicle
vᵣₑₗ: relative speed
v_{front}: speed of preceding vehicle
D: proper inter-vehicle distance

Here, the proper inter-vehicle distance D may be determined from a map representing the inter-vehicle distance depending on the current vehicle speed and the relative speed.

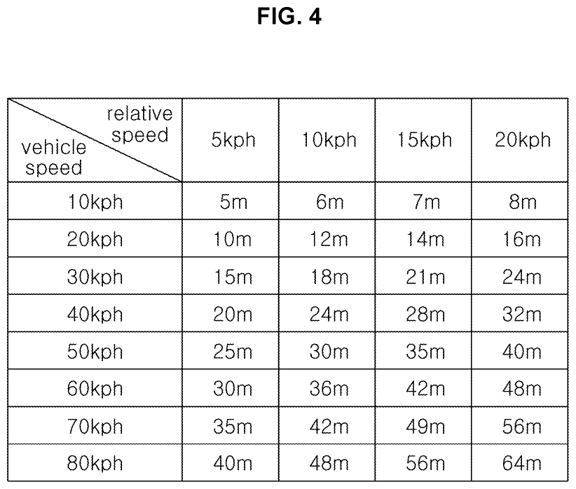

Of course, the map is designed in advance by a number of experimentations and analyses, and a single map may be provided, as shown in FIG. 4, or a plurality of maps or three-dimensional maps may be provided so that a user may select a desired map to set the proper inter-vehicle distance to a longer or shorter distance even at the same current vehicle speed and relative speed.

When a preceding vehicle is present ahead on the road on which the vehicle is running, the controller 1, which has obtained information related to the preceding vehicle from equipment, such as the front camera 13 or the front radio detection and ranging (RADAR) 15, is configured to determine the deceleration for moving obstacles by the above-described equations, is configured to determine the required torque, and satisfies the required torque preferentially using regenerative braking of the vehicle, being capable of maximally performing regenerative braking as much as possible while decelerating the vehicle to maintain the proper inter-vehicle distance with the preceding vehicle.

Here, the deceleration for moving obstacles a_{ref} becomes a value based on Mode 1 when the deceleration for moving obstacles a_{ref} is determined using a_{ca} in Mode 1, and becomes a value based on Mode 2 when the deceleration for moving obstacles a_{ref} is determined using a_{ca} in Mode 2.

The deceleration for moving obstacles based on Mode 1 is a deceleration which is determined on the assumption that the position of the preceding vehicle is fixed, and is advantageous in maintaining the inter-vehicle distance during braking of the preceding vehicle because the inter-vehicle distance tends to increase as much as the moving distance of the preceding vehicle.

On the other hand, the deceleration for moving obstacles based on Mode 2 is a deceleration which is determined on the assumption that the preceding vehicle is cruising, and is advantageous in maintaining a desired inter-vehicle distance during cruising of the preceding vehicle.

In an exemplary embodiment of the present disclosure, the mode selection switch 17 is provided to allow a user to select one of the first mode and the second mode so that the deceleration for moving obstacles is determined based on the first mode and applied, or determined based on the second mode and applied, being capable of satisfying more various user requirements.

When the downhill cruise condition is satisfied but the preliminary obstacle is present ahead, the target deceleration is set to the minimum value among the above candidate decelerations.

That is, the controller 1 sets the target deceleration to the minimum value among the above-described candidate decelerations, in a situation in which the downhill cruise condition is satisfied, but a speed camera or a preceding vehicle is present ahead and thus it is difficult for the vehicle to simply cruise on a downhill road, allowing the vehicle to maximally perform regenerative braking as much as possible while decelerating the vehicle while obeying a speed limit regulated by the speed camera or maintaining a desired inter-vehicle distance with the preceding vehicle.

The required torque may be determined by adding slope compensation torque, air resistance compensation torque, and rolling resistance compensation torque to reference torque, obtained by multiplying the target deceleration by the vehicle weight and a dynamic loaded radius of tires.

Such determination of the required torque may be referred to as vehicle dynamics-based open loop control, and in the instant case, the slope compensation torque, the air resistance compensation torque, and the rolling resistance compensation torque are conventionally obtained based on vehicle dynamics and a detailed description of determination methods thereof will thus be omitted.

Otherwise, the required torque may be determined by adding the slope compensation torque and feedback compensation torque to the reference torque, obtained by multiplying the target deceleration by the vehicle weight and the dynamic loaded radius of the tires.

Such determination of the required torque may be referred to as feedback control configured to track the target deceleration.

Here, the feedback compensation torque may be determined by the following equation.

$${T}_{fb} = {T}_{mot} + {T}_{rtd} - r \times \hat{m} \times {a}_{veh}$$

T_{fb}: feedback compensation torque
Tₘₒₜ: motor torque
T_{rtd}: retarder torque
r: dynamic loaded radius of tires
\hat{m}: estimated vehicle weight
aᵥₑₕ: current acceleration of vehicle

That is, the motor torque and the retarder torque may be torques which are commanded to the motor 7 and the retarder 9 by the controller 1, r×\hat{m}×aᵥₑₕ may be torque determined based on the current acceleration of the vehicle, and the feedback compensation torque may be a difference between a command value and a result value thereby.

In generating the required torque in the vehicle, when the vehicle speed is reduced to a designated conversion speed or less than the designated conversion speed, regenerative braking torque may be controlled to be gradually substituted with retarder torque.

Regenerative braking by the motor 7 may be prohibited at a certain lower vehicle speed limit for reasons, such as securement of durability of a transmission due to characteristics of the transmission used in vehicles, and in view thereof, when the vehicle speed is reduced to the conversion speed, which is set to a slightly higher speed than the lower vehicle speed limit, or less, the regenerative braking torque generated by the motor 7 may be gradually substituted with retarder torque so as not to perform regenerative braking by the motor 7 at the lower vehicle speed limit or less, being capable of preventing durability deterioration of the vehicle.

That is, for example, on the assumption that the lower vehicle speed limit is 20 kph, the conversion speed may be set to 23 kph, which is slightly higher than the lower vehicle speed limit, and the regenerative braking torque is gradually substituted with the retarder torque when the vehicle speed is reduced to 23 kph as regenerative braking according to an exemplary embodiment of the present disclosure is performed, and the regenerative braking torque becomes 0 when the vehicle speed becomes 20 kph, to prevent durability deterioration of the transmission of the vehicle, or the like.

As is apparent from the above description, in a regenerative braking control method of a vehicle according to an exemplary embodiment of the present disclosure, an amount of regenerative braking suitable for a driving situation of the vehicle may be automatically controlled while improving driving convenience by minimizing driver's manipulation for regenerative braking, to greatly improve energy efficiency of the vehicle.

Furthermore, the term related to a control device such as “controller”, “control apparatus”, “control unit”, “control device”, “control module”, or “server”, etc. refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A regenerative braking control method of a vehicle, the method comprising:
determining, by a controller, whether or not a designated downhill cruise condition is satisfied, in response that an accelerator pedal is released in an ON state of a regenerative braking switch;
setting a target deceleration of the vehicle to a designated deceleration for downhill cruising, in response that a designated preliminary obstacle is not present ahead of the vehicle, upon concluding that the downhill cruise condition is satisfied;
determining torque required for the vehicle to decelerate at the target deceleration; and
generating the required torque in the vehicle using regenerative braking.

2. The regenerative braking control method of claim 1, wherein the controller concludes that the downhill cruise condition is satisfied, in response that a current vehicle speed is equal to or greater than a target vehicle speed determined by adding a designated pre-input vehicle speed value to a vehicle speed in response that the accelerator pedal is released in the ON state of the regenerative braking switch.

3. The regenerative braking control method of claim 2, wherein, upon concluding that the downhill cruise condition is not satisfied, the target deceleration is set to a minimum value among candidate decelerations determined depending on a slope of a road on which the vehicle is running and the preliminary obstacle.

4. The regenerative braking control method of claim 3, wherein
in response that the road on which the vehicle is running is a flat road or an uphill road, one of the candidate decelerations is determined a deceleration for coasting; and
the deceleration for coasting is a predetermined constant value.

5. The regenerative braking control method of claim 3, wherein
in response that the road on which the vehicle is running is a downhill road, one of the candidate decelerations is determined the deceleration for downhill cruising; and
the deceleration for downhill cruising is set depending on a difference between the target vehicle speed and the current vehicle speed.

6. The regenerative braking control method of claim 3, wherein
in response that the preliminary obstacle is a speed camera, one of the candidate decelerations is determined a deceleration for stationary obstacles; and
the deceleration for stationary obstacles is set to a deceleration required for the vehicle to reach a speed limit of the speed camera, in response that the vehicle reaches an enforcement position of the speed camera.

7. The regenerative braking control method of claim 6, wherein the deceleration for stationary obstacles is determined by a following Equation:
$${a}_{cam} = \frac{( {v}_{cam}^{2} - {v}_{cur}^{2} )}{2 \times max ( {d}_{cam} , {d}_{min} )} ,$$
wherein
a_{cam}: deceleration for stationary obstacles;
v_{cam}: speed limit of limit camera;
v_{cur}: current vehicle speed;
d_{cam}: distance from current position of vehicle to speed camera; and
dₘᵢₙ: minimum distance for preventing division by zero.

8. The regenerative braking control method of claim 3, wherein
in response that the preliminary obstacle is a preceding vehicle, one of the candidate decelerations is determined a deceleration for moving obstacles; and
the deceleration for the moving obstacles is set to a deceleration required for the vehicle to maintain a proper inter-vehicle distance with the preceding vehicle.

9. The regenerative braking control method of claim 8, wherein the deceleration for moving obstacles is one selected from a deceleration for moving obstacles based on a first mode configured to be advantageous in maintaining the proper inter-vehicle distance with the preceding vehicle during braking of the preceding vehicle, and a deceleration for moving obstacles based on a second mode configured to be advantageous in maintaining the proper inter-vehicle distance with the preceding vehicle during cruising of the preceding vehicle.

10. The regenerative braking control method of claim 9, wherein the deceleration for moving obstacles is determined by following Equations:
$${a}_{ref} = β \times {a}_{ctg} + ( 1 - β ) \times {a}_{ca} \\ {a}_{ctg} = - \frac{1}{h} [ λ ( {v}_{ego} \times h + {d}_{min} - {d}_{rel} ) - {v}_{rel} ] \\ {a}_{ca} = \frac{( {v}_{front}^{2} - {v}_{ego}^{2} )}{2 \times {d}_{rel}} at Mode 1 \\ {a}_{ca} = \frac{{( {v}_{front} - {v}_{ego} )}^{2}}{2 \times ( {d}_{rel} - D )} at Mode 2 ,$$
wherein
a_{ref}: deceleration for moving obstacles;
β: mixing ratio (tuning value depending on relative speed and relative distance);
h: time gap constant in constant time gap control;
λ: sliding gradient (as sliding gradient increases, distance control becomes faster);
v_{ego}: speed of host vehicle;
dₘᵢₙ: minimum distance to be maintained;
dᵣₑₗ: distance with preceding vehicle;
vᵣₑₗ: relative speed;
v_{front}: speed of preceding vehicle; and
D: proper inter-vehicle distance.

11. The regenerative braking control method of claim 10, wherein the proper inter-vehicle distance D is determined from a map representing an inter-vehicle distance depending on the current vehicle speed and a relative speed of the vehicle.

12. The regenerative braking control method of claim 3, wherein, upon concluding that the downhill cruise condition is satisfied, in response that the preliminary obstacle is present ahead, the target deceleration is set to the minimum value among the candidate decelerations.

13. The regenerative braking control method of claim 1, wherein the required torque is determined by adding slope compensation torque, air resistance compensation torque, and rolling resistance compensation torque to reference torque, obtained by multiplying the target deceleration by a vehicle weight and a dynamic loaded radius of tires.

14. The regenerative braking control method of claim 1, wherein the required torque is determined by adding slope compensation torque and feedback compensation torque to reference torque, obtained by multiplying the target deceleration by a vehicle weight and a dynamic loaded radius of tires.

15. The regenerative braking control method of claim 14, wherein the feedback compensation torque is determined by a following equation:
$${T}_{fb} = {T}_{mot} + {T}_{rtd} - r \times \hat{m} \times {a}_{veh} ,$$
wherein
T_{fb}: feedback compensation torque;
Tₘₒₜ: motor torque;
T_{rtd}: retarder torque;
r: dynamic loaded radius of tires;
\hat{m}: estimated vehicle weight; and
aᵥₑₕ: current acceleration of vehicle.

16. The regenerative braking control method of claim 1, wherein, in generating the required torque in the vehicle, in response that a vehicle speed is reduced to a designated conversion speed or less than the designated conversion speed, regenerative braking torque is substituted with retarder torque.

17. A regenerative braking control system of a vehicle, the system comprising:
a controller configured to execute the regenerative braking control method of claim 1,
the regenerative braking switch configured to provide a signal indicating user's selection of activation of a regenerative braking function of the vehicle to the controller;
an accelerator pedal sensor configured to detect release of the accelerator pedal and to provide information related to the accelerator pedal to the controller; and
a motor and a retarder controlled by the controller and configured to generate the required torque in the vehicle.

18. The regenerative braking control system of claim 17, further including:
a navigation system configured to provide information related to speed cameras ahead on a road on which the vehicle is running; and
at least one of a front camera or a front radio detection and ranging (RADAR) configured to detect information related to preceding vehicles ahead on the road on which the vehicle is running.

19. The regenerative braking control system of claim 17, further including a mode selection switch configured to select determination of the target deceleration as a different value, in response that a preceding vehicle is present ahead.
